(19) United States
(12) Patent Application Publication
(10) Pub. No.: US 2020/0352139 A1
(43) Pub. Date: Nov. 12, 2020

(54) PROCESS FOR MATCHING PET OWNERS IN NEED OF EXCHANGE PET SITTING AND/OR SETTING UP PLAYDATES

(71) Applicant: Samantha Maung, Ellicott City, MD (US)

(72) Inventor: Samantha Maung, Ellicott City, MD (US)

(21) Appl. No.: 16/792,985

(22) Filed: Feb. 18, 2020

Related U.S. Application Data
(60) Provisional application No. 62/846,683, filed on May 12, 2019.

(51) Int. Cl. A01K 29/00; G06Q 50/10; G06Q 10/02; G06Q 10/06

(52) U.S. Cl. CPC A01K 29/005; G06Q 10/063112; G06Q 10/02; G06Q 50/10

(57) ABSTRACT

A system managed by an Application Service provider (ASP) for matching pet owners in need of exchange pet sitting and/or setting up playdates. The ASP maintains database comprising a plurality of pet records each including pet owner's name, email, city and state of residence, last rabies shot date and if the pet is sterilized or not. The ASP also provides a user dashboard to each pet owner that allows a pet owner to submit a request for exchange dog-sitting and/or for a pet playdate. If a pet owner submits a request for exchange dog-sitting, the dashboard automatically displays a filtered subset of the database file reflecting only pets which owners designated ‘yes’ for exchange dog-sitting. If, on the other hand, the pet owner submits a request for a playdate, the dashboard automatically displays a filtered subset of the database file reflecting only pets which owners designated ‘yes’ for playdates.

### CROSS-REFERENCE TO RELATED APPLICATIONS

The present application derives priority from U.S. provisional application 62/846,683 filed May 10, 2019.

### BACKGROUND OF THE INVENTION

### 1. Field of the Invention

The present invention relates generally to computer processes and, in particular, a computer process for matching pet owners in need of pet sitting and/or walking.

### 2. Description of the Background

There are a variety of online web resources for pet owners, particularly for the advertising of pet related goods and services.

For example, U.S. patent application 20080172381 by Suh shows a computer-implemented method of facilitating system-wise reciprocal exchange of pet care services by member pet owners that assigns point values to various pet care services, matches a member with a pet in need with another member willing to provide that service, and then debits the appropriate number of points.

Similarly, United States Patent Application 20100174587 by Seidman et al. published Jul. 8, 2010 shows a pet service exchange marketplace that facilitates the matching of members desiring pet care services with other members willing to provide these services. Point values may be established for various services and these points may be debited or credited to members of the pet care service marketplace in exchange for the performance of pet care services.

Despite the foregoing there are particular pet-related services that are still difficult to find on-demand. For example, pet owners have few options for pet-sitting or even walking their pets while traveling. Those options include professional boarding or kenneling, or asking family or friends. However, boarding a pet is expensive, and asking family or friends can be taxing to personal relationships. Moreover, both options require significant advance planning. They simply do not work for on-demand needs, such as when the pet owner simply cannot get home in time, or seeks a pet sitter that same day, or for a short period of time. Similarly, there are very few options for simple pet socialization, e.g., arranging play dates with other pets. This typically requires knowledge of other willing pet owners. What is needed is an on-demand exchange for pet-related services and socialization that does not ascribe point values to the services.

Relevant online exchanges exist for other types of services such as business services. Typically the input is a structured query and the output is a list of provider organizations and corresponding contact data. While these online sites serve their purpose in connecting customers to established businesses, they are curated and ad-based. Established commercial providers have the benefit of advertising and voluminous positive rankings. This does not work well for pet services. For example, when eighteen year old Susan comes home from college for the summer and wants to pet sit she has no established profile, no track record, no customer feedback, and no resources to subscribe to expensive referral services. There is no suitable matching service to facilitate. Moreover, Susan's pet-related services are inherently localized as pet owners must be in her neighborhood. Susan's only recourse is to distribute flyers in mail boxes throughout her neighborhood.

Accordingly there is substantial need for a non-fee-based web-based pet exchange application generally directed to matching one pet owner with an on-demand need for pet-related services, including walking, pet socializing and playdates, with another willing and capable pet-owner, based on profiling of the parties for parameters that are relevant to making a match. The present invention accomplishes that with improved registration and profiling techniques, plus techniques that allow searchers in geographical proximity to be matched. There are many other problems and needs addressed by the inventive subject matter disclosed herein.

### SUMMARY OF THE INVENTION

According to embodiments of the invention, the system includes a plurality of personal computers or portable devices such as “smart phones” used by each pet owner, and a third party Application Service Provider (ASP) providing Software as a Service (SaaS) via one or more back-end application servers configured with ASP software, all connected via a communications network.

The ASP maintains database comprising a plurality of pet records each including each including pet owner's name, email, city and state of residence, last rabies shot date and if the pet is sterilized or not. The ASP also provides a user dashboard to each pet owner that allows a pet owner to submit a request for exchange dog-sitting and/or for a pet playdate. If a pet owner submits a request for exchange dog-sitting, the dashboard automatically displays a filtered subset of the database file reflecting only pets which owners designated ‘yes’ for exchange dog-sitting. If, on the other hand, the pet owner submits a request for a playdate, the dashboard automatically displays a filtered subset of the database file reflecting only pets which owners designated ‘yes’ for playdates. The pet owner can correspond directly.

The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which.

FIG. 1 is a screen print of an exemplary home page.

FIG. 2 is a block diagram illustrating a distributed network system and architecture suitable for implementing the computer-implemented method of the invention;

FIG. 3 is a screen print of the PetFacts data entry dashboard;

FIG. 4 is a process diagram illustrating the stepwise sequence of matching a party with another party according to an embodiment of the invention;

FIG. 5 is a screen print of the Set Playdate display;

FIG. 6 is a screen print of the Dogsit Exchange display.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

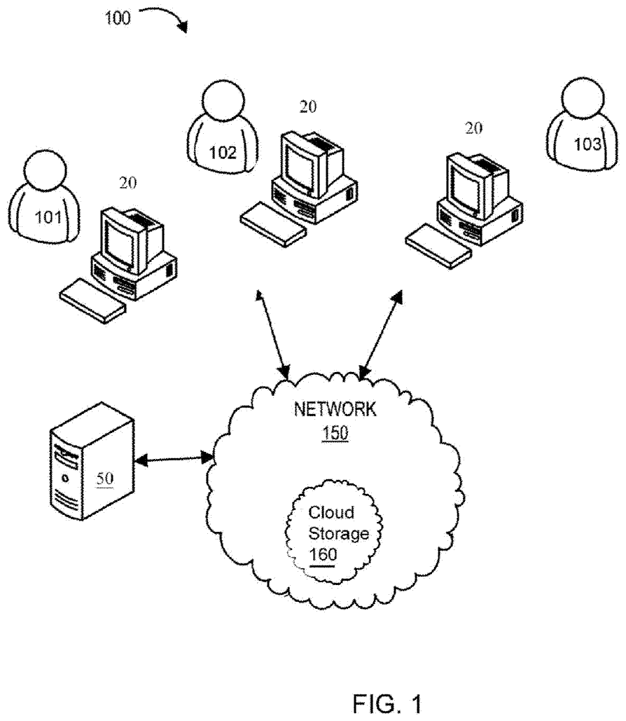

As illustrated in the block diagram of FIG. 1, system 100 is an online exchange for pet owners 101, 102, 103. An embodiment of system 100 is herein described to facilitate pet-sitting and socialization of dogs, including arranging playdates and dog sitting services. The system 100 compels certain data entry about each subscribed pet owner 101, 102, 103, and facilitates correspondence between a pet owner 101 in need of pet sitting and/or a socialization play date with another pet owner 102 willing-and-able to provide same. One skilled in the art should understand that any number of pet owners 110-130 may participate.

Pet owners 101-103 each access the system 100 via a personal computer 20 configured to communicate over a network 150 managed by a back-end Application Service Provider (ASP) system 50. As used herein, a “personal computer” 20 includes conventional desktop and laptop computers and any smart mobile communication device, such as a cellular telecommunications device (i.e., a cell phone or mobile phone), personal digital assistant (PDA), a mobile Internet accessing device, or other mobile device.

The present system 100 employs a permissions hierarchy for network 150 that is managed by an Application Service Provider (ASP) 50, and full access to sections of the website is limited to subscribed pet owners 101-103, employees of back-end Application Service Provider (ASP) system 50, and any other preauthorized entities. The ASP 50 provides Software as a Service (SaaS) via communications network 150.

The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network.

In the context of the above-described architecture, a system and method for matching a pet owner 101 with another pet owner 102 is disclosed based on data entry/profiling of the parties, and intelligent matching of parameters that are relevant to making a match. The sophisticated matching of pet owners leverages improved registration and profiling techniques, plus techniques that allow searchers in geographical proximity to be matched.

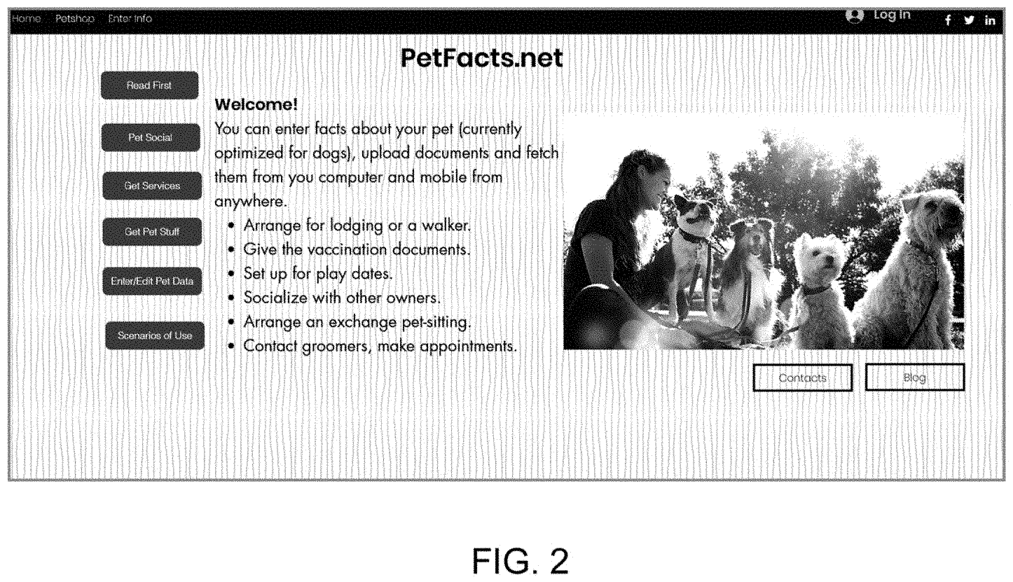

Use of the system 100 begins at a home page as shown in FIG. 2. The ASP provides a home page to each party on their PC 20 (and/or mobile dashboard by iOS or Android applications on mobile devices) that facilitates development of consolidated pet owner/pet profile, and that facilitates submission of service requests. All the dashboards for PCs 20 intercommunicate via network 150 and thereby provide a collaboration platform by which matching pet owners are determined and displayed along with contact and pet information. A pet owner needing service can review suitable matches ranked by location and correspond directly. The result is that a pet owner seeking pet sitting or a play date from another localized pet owner can find it on demand.

Each pet owner 101, 102, 103 is assigned login credentials by ASP 50 and in order to access the respective user account(s) must authenticate with the ASP 50. For example, logging in generally requires that the pet owner 101, 102, 103 authenticate his/her identity using a user name and single-authentication passcode or password. The dashboard of FIG. 2 includes several sequential screens for implementing the present workflow to facilitate development of a pet and owner profile, entry of requests, geographical filtering and display, and pet owner outreach.

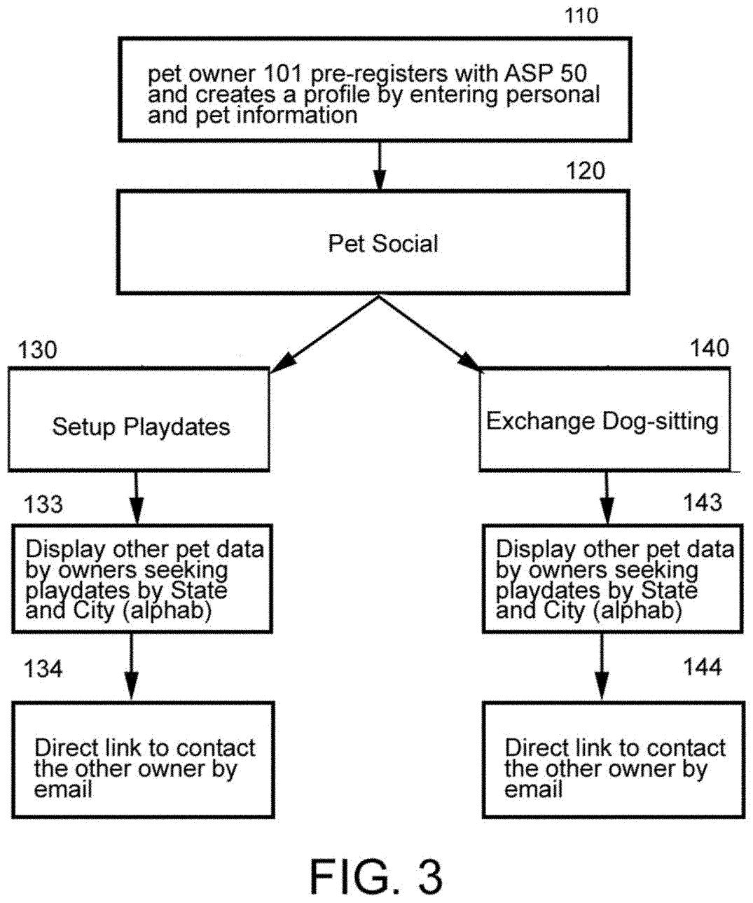

FIG. 3 is a more detailed flow diagram showing the present workflow. At step 110 the pet owner 101 pre-registers with ASP 50 and creates a profile by entering personal and pet information. In an embodiment pet owner 101 must enter a different email for each pet, and each email is specific for one pet only. However, each registered pet owner 101 may enter different pets and different emails for each pet. Thus, for example, if a pet owner John Doe has two dogs, Snowy and Bruno, he must register with two different emails: john.doe@gmail.com and john.doe@hotmail.com. This effectively ensures that each pet is associated with a unique identifier, and that an email address is that primary key in the database.

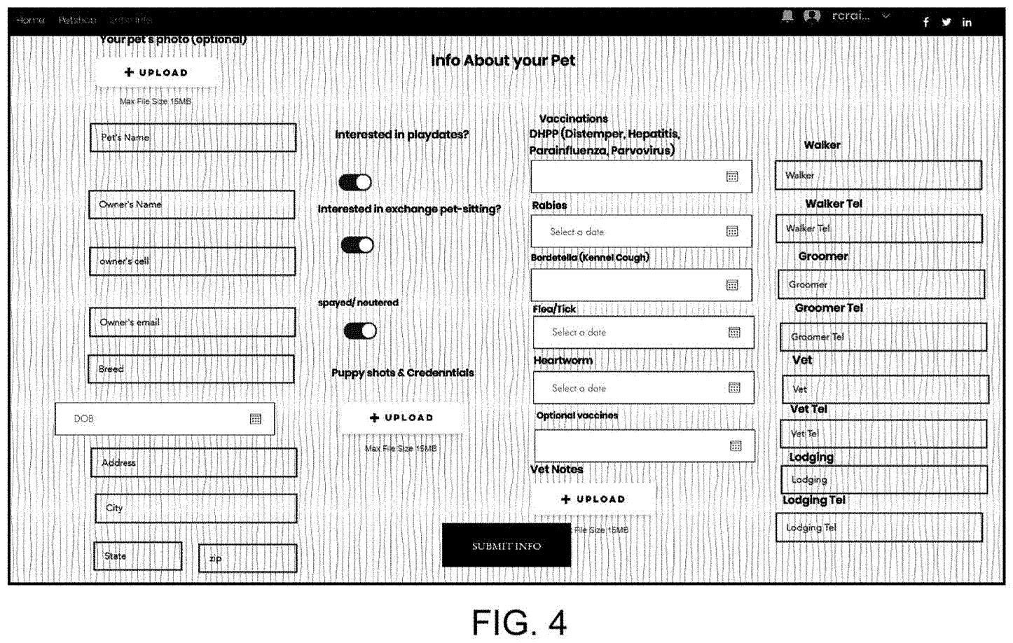

FIG. 4 is a screen shot of the data entry screen. Information collected at this point includes 1) demographics; 2) medical data; 3) pet owner information; and 4) services as follows:

Demographics:

An uploaded pet photo (optional), Pet's Name, Pet Breed, Address, City, State and ZIP.

Medical Data:

The pet owner 101 is then asked a few yes/no questions such as spayed/neutered? Next, the pet owner is solicited to upload the pet's medical record (puppy shots & credentials, and is asked to enter specific vaccination dates by calendar entry, including: HPP (Distemper, Hepatitis, Parainfluenza, Parvovirus); Rabies; Bordetella (Kennel Cough); Flea/Tick; Heartworm; and Optional vaccines. Any Vet Notes can be uploaded.

Pet Owner Information:

Owner's Name, Owner's Cell #, Owner's email, Pet Breed, Address, City, State and ZIP.

Service Information:

Interested in playdates?; Interested in exchange pet-sitting?; significant contact information of, for example, Walker name, Walker telephone number, Groomer name, Groomer telephone number, Vet name, Vet telephone number, and Daycare name and telephone number.

All the foregoing entered data is used to populate tables and the uploaded documents (like the Vet's documents) are saved unaltered. This way, whenever needed the owners can be retrieve such documents from their computers or mobile phones. A unique pet ID is automatically generated and associated with the pet profile. The database is preferably cloud based. Various commercially available cloud service providers exist. For example, the Microsoft AZURE® Services Platform is an internet-scale cloud services platform hosted in data centers operated by Microsoft Corporation. The AZURE® Services lets developers act as a service provider from the AZURE® Services Platform, which provides an operating system and a set of developer tools.

Upon hitting ‘Submit Data’ all data is immediately stored in the database table. The data can be edited/updated using the ‘Get/Edit my Data’ button appearing in subsequent pages.

Referring back to FIGS. 2 and 3, registered pet owners 101, 102, 103 can then visit the Pet Social page at step 120 to arrange play dates, dog sitters, etc. The Pet Social page presents two options: at step 130 a pet owner 101 can Setup Playdates; and at step 140 the pet owner 101 can Exchange Dog-sitting. New data overwrites old and no duplicate data is allowed. Thus, if a pet owner 101 chooses to setup a Playdate at step 130, the system 100 automatically displays a filtered and sorted subset of the database file in which only those pets which owners designated ‘yes’ for Playdates at step 110 are shown, only relevant data fields are shown, and records are compound-sorted by multiple fields.

A “Filter” is herein defined as a criteria that displays only a subset of the data in the database. A filter is a query that searches all of the records in the table, finds the ones that meet the criteria, display only those results. Viewing filtered data is far more efficient than searching for it in a large table. In an embodiment, the present filter is accomplished by querying the dataset only for pets which owners designated ‘yes’ for Playdates at step 110. Consequently, at step 133 only dogs with owners that agreed to playdates are displayed.

“Sort” is herein defined as sorting records by putting them into a logical order with similar data grouped together. Sorted data is simpler to read and understand than unsorted data. In an embodiment the displayed records are ordered by closest proximity to the querying pet owner 101. Specifically, records may be compound-sorted by multiple geographic fields (state, city, and then ZIP) to ensure ordering by closest proximity to the querying pet owner 101.

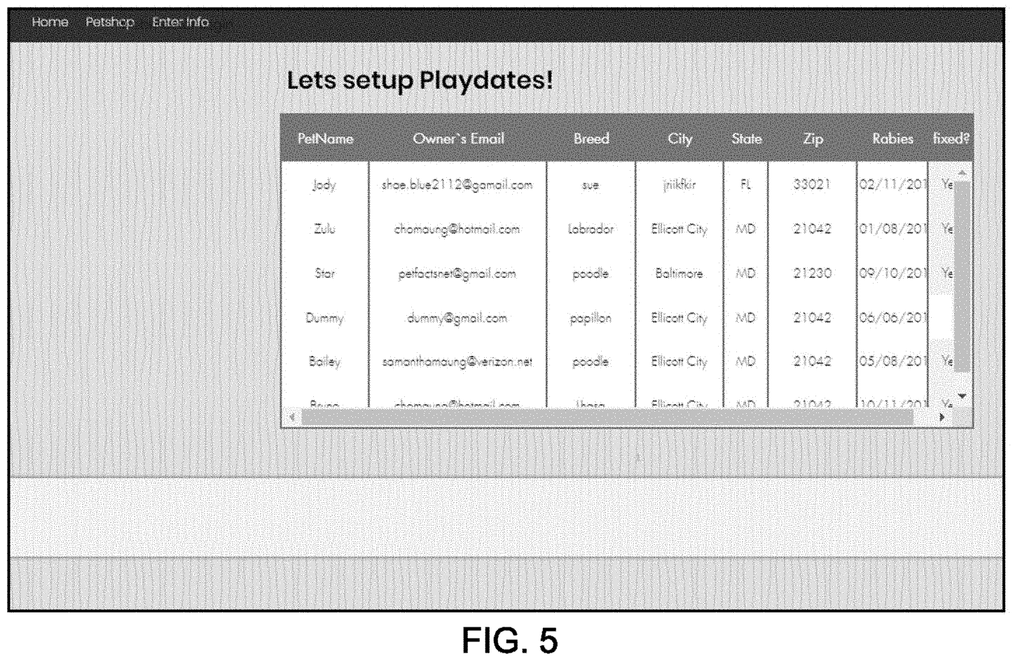

FIG. 5 is a screen print of the retrieved filtered table. The table is filtered by pet owners that have designated ‘yes’ for Playdates at step 110. In this instance the filtered dataset is sorted and displayed alphabetically by State and City. Adjacent thereto a limited subset of pet and owner data is also displayed including Owner's email, breed, if fixed, rabies shot date. The filtered display at step 133 may be accomplished with a JavaScript Table Filter (or Search for HTML Tables) using the Java script .getAttribute method, e.g., in the JavaScript section of the Playdate button use the HTML data-* (get info) attribute to search and sort the table. The filter may be attached to the dataset using a JavaScript Table Filter function filter(row), function_filter(row). If any data matches the input then it is displayed. Only the essential facts are displayed from the table: pet owner's name, email, city and State of residence, last rabies shot date and if the dog is sterilized or not are viewable.

At step 134 if the pet owner 101 is interested in any listing they simply contact the other owner 102 by email, and correspond directly to set up a time and place if agreeable. It is the owners' responsibility to discuss with the other party about the sex of dogs, temper, illnesses, transmissible conditions. They can also discuss about the sex, marital status, occupation, hobbies of the owner. The site does not give any unnecessary personal info about owners.

If the user chooses to Exchange Dog-sitting at step 140, the system 100 automatically displays a filtered version of the database file in which only those pet owners that have designated ‘yes’ for exchanging dog-sitting at step 110 are shown. This is likewise accomplished with a JavaScript Table Filter (or Search for HTML Tables). In the JavaScript section of the Playdate button use the HTML data-* (get info) attribute to search and sort the table, with a filter attached to the dataset using a JavaScript Table Filter function filter(row). Again if any data matches the input then it is sorted as above and displayed.

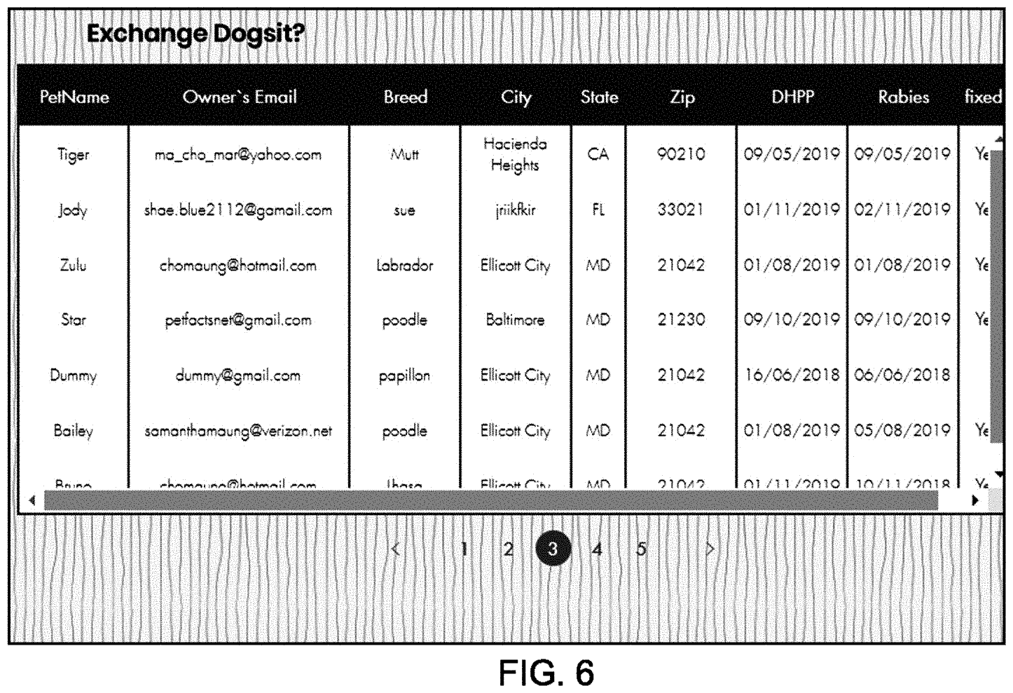

FIG. 6 is a screen print of the retrieved filtered and sorted table. The table is filtered by pet owners that have designated ‘yes’ for Exchange Dog-sitting at step 110, and is compound-sorted by location, state and city alphabetically, or alternatively by proximity of ZIP code. The table is likewise accessed using the Java script .getAttribute method, the filtering is accomplished using a function called function_filter(row). If any data matches the input then it is displayed.

At step 150 should the pet owner wish to solicit another pet owner for any particular job they simply click the email and begin to correspond directly. This engenders an email dialogue clarifying parameters. For example, it is the owners' responsibility to discuss with the other party about the sex of dogs, temper, illnesses, transmissible conditions. They can also discuss about the sex, marital status, occupation, hobbies of the owner. The site does not give any unnecessary personal info about owners. If interested, an owner emails the other, ask questions, arranges for the venue and do the playdate.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A distributed system for matching pet owners in need of services to other pet owners willing to provide said service, comprising:
a host computer in communication with a plurality of remote client computers via at least one communications network, said host computer including a processor and non-transitory storage media;
a database resident on the non-transitory storage media, said database comprising a plurality of pet records each including each including pet owner's name, email, city and state of residence, last rabies shot date and if the pet is sterilized or not;
a user dashboard operable on all authorized user devices and configured to execute computer-readable program code to perform the steps of,
allowing a pet owner to submit a request to exchange dog-sitting and to submit a request for a pet playdate,
automatically displaying a filtered and sorted subset of the database file reflecting only pets which owners designated ‘yes’ for exchange dog-sitting, and
automatically displaying a filtered and sorted subset of the database file reflecting only pets which owners designated ‘yes’ for playdates.

2. The system of claim 1, wherein said plurality of pet records each further include pet demographics, pet medical data, and pet owner information.

3. The system of claim 1, wherein said step of automatically displaying a filtered and sorted subset of the database file reflecting only pets which owners designated ‘yes’ for playdates comprises a first compound-sorted subset.

4. The system of claim 3, wherein said first compound-sorted subset is compound-sorted by state, city and ZIP code.

5. The system of claim 4, wherein said step of automatically displaying a filtered and sorted subset of the database file reflecting only pets which owners designated ‘yes’ for exchange dog-sitting comprises a second compound-sorted subset.

6. The system of claim 5, wherein said second compound-sorted subset is compound-sorted by state, city and ZIP code.

7. The system of claim 1, wherein said plurality of pet records each further include pet demographics, pet medical data, and pet owner information.

8. The system of claim 7, wherein each of said plurality of pet records is associated with a unique identifier.

9. The system of claim 8, wherein each of said unique identifiers comprises a unique email address.

10. The system of claim 2, wherein said pet demographics comprises a pet photo.

11. The system of claim 2, wherein said pet demographics comprises pet name, pet breed, address, city, state and zip.

12. The system of claim 2, wherein said pet medical data indicates spayed/neutered.

13. The system of claim 2, wherein said pet medical data includes vaccination dates chosen from among a group consisting of HPP, Rabies, Bordetella, Flea & Tick, and Heartworm.

14. The system of claim 2, wherein said pet owner information includes at least owner's name, owner's cell #, owner's email, pet breed, address, city, state and zip.

15. The system of claim 2, wherein said service information indicates whether said pet owner is interested in playdates, exchange pet-sitting.

16. The system of claim 8, wherein said service information includes walker name, walker telephone number, groomer name, groomer telephone number, vet name, vet telephone number, and daycare name and telephone number.

17. The system of claim 1, wherein said step of automatically displaying a filtered subset of the database file reflecting only pets which owners designated ‘yes’ for exchange dog-sitting comprises a substep of attaching a filter to the dataset by filter(row) and if any data matches the input then displaying it in alphabetical order.

18. The system of claim 1, wherein said step of automatically displaying a filtered subset of the database file reflecting only pets which owners designated ‘yes’ for playdates comprises a substep of attaching a filter to the dataset by filter(row) and if any data matches the input then displaying it in alphabetical order.

19. A distributed system for matching pet owners in need of services to other pet owners willing to provide said service, comprising:
a host computer in communication with a plurality of remote client computers via at least one communications network, said host computer including a processor and non-transitory storage media;
a database resident on the non-transitory storage media, said database comprising a plurality of pet records each including each including pet owner's name, email, city and state of residence, last rabies shot date and if the pet is sterilized or not;
a user dashboard operable on all authorized user devices and configured to execute computer-readable program code to perform the steps of,
allowing a pet owner to submit a request to exchange dog-sitting and to submit a request for a pet playdate,
attaching a filter to the dataset by filter(row) to display only pet owners requesting pet playdates and if any data matches the input then displaying it in alphabetical order,
attaching a filter to the dataset by filter(row) to display only pet owners requesting dog-sitting and if any data matches the input then displaying it in alphabetical order;
automatically displaying a filtered and compound-sorted subset of the database file reflecting only pets which owners designated ‘yes’ for playdates;
automatically displaying a filtered and compound-sorted subset of the database file reflecting only pets which owners designated ‘yes’ for exchange dog-sitting.

20. The distributed system of claim 19, wherein said first compound-sorted subset and said second compound-sorted subset are both compound-sorted by state, city and ZIP code.
